(19) United States
(12) Patent Application Publication
(10) Pub. No.: US 2025/0306294 A1
(43) Pub. Date: Oct. 2, 2025

(54) On-Package Self-Aligning Expanded-Beam Connector

(71) Applicant: Intel Corporation, Santa Clara, CA (US)

(72) Inventors: Li YUAN, Fremont, CA (US); Fan FAN, Chandler, AZ (US); Kumar Abhishek SINGH, Phoenix, AZ (US); Saikumar JAYARAMAN, Chandler, AZ (US); Feifei CHENG, Chandler, AZ (US); Stephanie AROUH, Hillsboro, OR (US); Todd COONS, Gilbert, AZ (US); Wesley MORGAN, Lake Oswego, OR (US)

(21) Appl. No.: 18/616,268

(22) Filed: Mar. 26, 2024

(51) Int. Cl. G02B 6/38

(52) U.S. Cl. CPC G02B 6/3885; G02B 6/3883; G02B 6/3893; G02B 6/3897

(57) ABSTRACT

In the various aspects, an optical package includes an optical connector that is at least partially configured with a first thickness that is less than a second thickness of the optical package. The optical package includes an assembly platform, a photonic integrated circuit disposed on the assembly platform, and the optical connector includes a housing with a first section and a second section, and an attachment assembly. In an aspect, the first section of the housing is disposed proximally to an edge of the assembly platform and is coupled to the photonic integrated circuit in the optical package, and the second section of the housing is coupled to a fiber optic jumper, and the attachment assembly joins the second section to the first section and enables the second section to be detached from the first section.

### STATEMENT OF GOVERNMENT INTEREST

This Invention was made with Government support under Agreement No. N00164-19-9-0001, awarded by NSWC Crane Division. The Government has certain rights in the Invention.

### BACKGROUND

For integrated circuit design and fabrication, the need to improve performance and lower are constant challenges. Co-packaged optics (CPO) integrates electronic integrated circuits (EIC) and photonic integrated circuits (PICs) on a single package to address the increasing bandwidth and power challenges. PICs are microchips that generate information signals using light pulses for communication and computation. The PIC integrates multiple light-based or photonics components, such as lasers, waveguides, amplifiers, modulators, and detectors, onto a single platform to perform functions related to the generation, manipulation, and detection of light. The light signals may experience attenuation during their journey through the various optical components on the PIC which may impact the overall circuit efficiency.

Other challenges of CPO include providing the optical interfaces between PICs and the fibers, interfaces with external lasers, if any, and preventing propagation losses. Directly attaching fibers, i.e., without using connectors, may expose the photonic packages to reliability risks during operation. For example, during shock and vibration operations, conventional pigtail fiber arrays may overstress the PIC die and cause the optical/photonics package to fail. A conventional physical contact connector at the end of a pigtail on the motherboard level may be prone to lose its function due to dust contamination. A detachable connector having a small form factor with passive alignment features that permits easy assembly and makes fiber replacement possible for board-level operators may help minimize dust-caused optical losses and improve package reliability.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. The dimensions of the various features or elements may be arbitrarily expanded or reduced for clarity. In the following description, various aspects of the present disclosure are described with reference to the following drawings, in which:

FIG. 1 shows an exemplary representation of an on-package optical connector according to an aspect of the present disclosure;

FIG. 2 shows an exemplary representation of an on-package optical connector according to another aspect of the present disclosure;

FIGS. 3, 3A, and 3B show exemplary representations of the housing of an on-package optical connector and the features therein according to an aspect of the present disclosure;

FIG. 4 shows an exemplary representation of an optical package assembly with an on-package optical connector according to an aspect of the present disclosure;

FIG. 5 shows an exemplary representation of an optical package assembly with an on-package optical connector according to another aspect of the present disclosure;

FIGS. 6A and 6B show exemplary representations of top and bottom views of an optical package assembly according to aspects of the present disclosure;

FIGS. 7A and 7B show exemplary representations of an optical package assembly according to yet another aspect of the present disclosure;

FIG. 8 shows an exemplary representation of an attachment assembly of an on-package optical connector according to an aspect of the present disclosure;

FIG. 9 shows an exemplary representation of an on-package optical connector according to another aspect of the present disclosure;

FIG. 10 shows an exemplary representation of alignment members of the present on-package optical connector according to an aspect of the present disclosure;

FIG. 11 shows an exemplary representation of alignment members of the present on-package optical connector according to another aspect of the present disclosure;

FIG. 12 shows an exemplary representation of alignment members of the present on-package optical connector according to yet another aspect of the present disclosure;

FIG. 13 shows an exemplary representation of alignment members of the present on-package optical connector according to an additional aspect of the present disclosure;

FIG. 14 shows an exemplary representation of an alignment member of the present on-package optical connector according to a further additional aspect of the present disclosure;

FIG. 15 shows an exemplary representation of on-package optical connectors according to an aspect of the present disclosure;

FIG. 16 shows an exemplary representation of on-package optical connectors according to an aspect of the present disclosure;

FIG. 17 shows an exemplary representation of an optical package assembly with on-package optical connectors, and FIG. 17A shows a cross-sectional view of a locking mechanism for an optical connector according to an aspect of the present disclosure;

FIG. 18 shows an exemplary representation of a locking mechanism of an on-package optical connector according to an aspect of the present disclosure;

FIG. 19 shows an exemplary representation of a locking mechanism of an on-package optical connector according to another aspect of the present disclosure;

FIG. 20 shows an exemplary representation of an on-package optical connector according to a further aspect of the present disclosure; and

FIG. 21 shows a simplified flow diagram for an exemplary method according to an aspect of the present disclosure.

### DETAILED DESCRIPTION

The following detailed description refers to the accompanying drawings that show, by way of illustration, specific details, and aspects in which the present disclosure may be practiced. These aspects are described in sufficient detail to enable those skilled in the art to practice the present disclosure. Various aspects are provided for devices, and various aspects are provided for methods. It will be understood that the basic properties of the devices also hold for the methods and vice versa. Other aspects may be utilized and structural, and logical changes may be made without departing from the scope of the present disclosure. The various aspects are not necessarily mutually exclusive, as some aspects can be combined with one or more other aspects to form new aspects.

According to the present disclosure, the present self-aligning, expanded-beam connector or optical connector may include a housing or body that uses glass blocks with V-grooves to support a plurality of fibers, i.e., a fiber array (FA), and a set of micro lens arrays (MLA) that are carefully attached to align with the tips of the FA. For example, the housing may have first and second sections, which may be glass blocks that are designed with alignment features, i.e., a male side may have grooves to attach alignment members or guiding pins, while a female side may have alignment member receptacles, e.g., holes or grooves, to receive or mate with the guide pins. In an aspect, the optical connector may include an extension section to “extend” the position of the first and second sections. All parts of the present connectors must have a small form factor to fit within an optical package assembly to be “on-board”. All materials for the connectors should be heat-resistant and compatible with standard solder reflow technology.

The present expanded-beam connectors offer reliable and low-maintenance solutions that may be suitable for harsh environments. The present connectors utilize a first MLA to expand and collimate the light emitting from an optical fiber. Expanded beam technology will expand and collimate the optical signal through the connector interface path resulting in a diameter that may be many times that of the original beam. The expanded optical beam may be refocused by a second MLA into the core of the receiving fiber. The expanded beam size allows for more lateral tolerances for achieving passive alignment with minimum signal losses and provides more robustness to dust.

In an aspect, the present optical connector for an optical package may have a housing or body that includes a first section, a second section, and an attachment assembly. The attachment assembly joins the first section to the second section and enables the second section to be detached from the first section. The first section of the housing is disposed proximally to an edge of a photonic integrated circuit that is a component in an optical package and is coupled by a fiber array to the photonic integrated circuit, while the second section of the housing is coupled to a fiber optic jumper. The housing of the present optical connector has dimensions that can be accommodated by the dimensions of the present optical package, i.e., a thickness of the housing for the optical connector is less than a second thickness of the optical package.

The present disclosure is also directed to a method that includes providing an assembly platform and disposing a photonic integrated circuit on the assembly platform to form an optical package. In addition, further providing an on-board optical connector comprising a housing with a first section and a second section, and an attachment assembly, and disposing the first section of the optical connector at an edge the assembly platform. The housing is configured with a first thickness that is less than a second thickness of the optical package and is formed using heat-tolerant materials. The method further includes performing one or more surface mounting processes to attach the photonic integrated circuit and other components to the assembly platform and disposing a cover over the first section of the optical connector and attaching it to the assembly platform.

The present disclosure is further directed to an optical package assembly including an assembly platform, a photonic integrated circuit disposed on the assembly platform, and a self-aligning optical connector including a housing with a first section and a second section, and an attachment assembly. In an aspect, the first section of the housing is disposed proximally to an edge of the assembly platform and is coupled to the photonic integrated circuit in the optical package, and the second section of the housing is coupled to a fiber optic jumper, and the attachment assembly joins the second section to the first section and enables the second section to be detached from the first section. In another aspect, the housing of the present optical connector is configured with a first thickness that is less than a second thickness of the optical package. In yet another aspect, the assembly platform may be a heat spreader.

The technical advantages of the present disclosure include, but are not limited to:
(i) providing an expanded beam connector for a photonic integrated circuit package having a housing with passive alignment features and a small form factor for positioning proximal to a photonic integrated circuit;
(ii) providing the passive alignment features with components that enable easy assembly, minimize coupling loss, and may be replaced; and
(iii) providing the housing with construction materials that are able to tolerate elevated temperatures and may be compatible with package solder reflow processes.

To more readily understand and put into practical effect the present self-aligned expanded beam connectors for use with photonic integrated circuit and methods therefor, which may provide improved photonic integrated circuit packages, particular aspects will now be described by way of examples provided in the drawings that are not intended as limitations. The advantages and features of the aspects herein disclosed will be apparent through reference to the following descriptions relating to the accompanying drawings. Furthermore, it is to be understood that the features of the various aspects described herein are not mutually exclusive and can exist in various combinations and permutations. For the sake of brevity, duplicate descriptions of features and properties may be omitted.

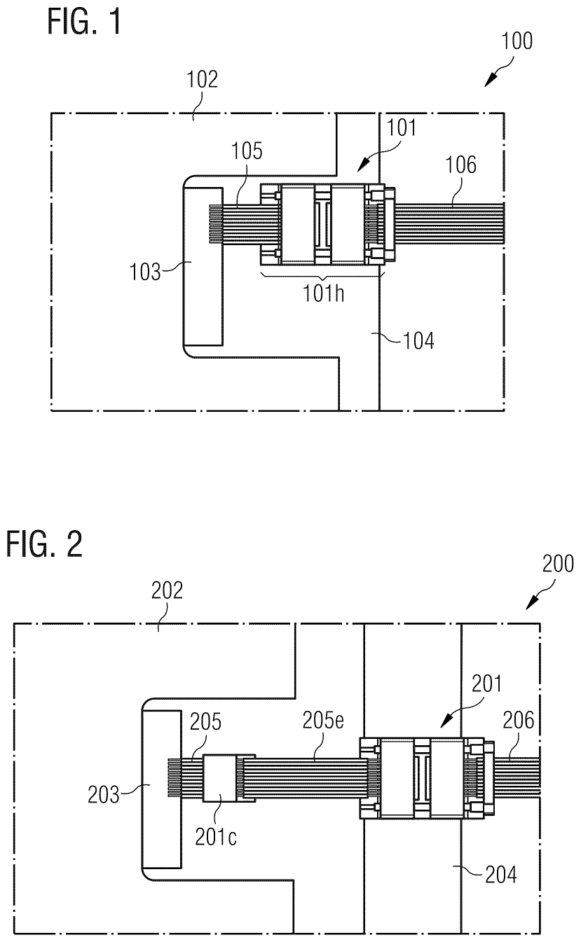

FIG. 1 shows an exemplary representation of an optical package assembly or package assembly 100 with an on-package optical connector or optical connector 101 with a housing 101h and optical package 102 having a photonic integrated circuit (PIC) 103, which may be attached to an assembly platform 104, according to an aspect of the present disclosure. In this aspect, an expanded beam fiber array or fiber array 105 may have a first end attached to the optical connector 101, and a second end of the fiber array 105 may be connected to the PIC 103. As shown in FIG. 1, the optical connector 101 may be disposed proximal to an edge of the assembly platform 104. In addition, the optical connector 101 may be connected to an expanded beam jumper fibers 106 for coupling the PIC 103 with other components. In an aspect, a height or first thickness for the optical connector 101 should be less than a height or second thickness of the optical package 102. In another aspect, the assembly platform 104 may be a working substrate or a heat spreader, which may be integral to the package assembly 100.

In another aspect, the present fibers used in the various fiber arrays and jumpers may be single mode (SM) fibers that are capable of carrying randomly polarized light or polarization maintaining (PM) fibers that are designed to propagate only one polarization of the input light. The present fibers may be attached using V-shaped grooves that may be formed, e.g., by etching, in the attachment surface, whereby the fibers may be placed in a jig, pressed into the grooves, and glued in place using, for example, a glue that may be cured by UV-light. If the fibers are slightly misaligned, the shape of the grooves will align them as they are pressed down.

For various aspects in the present disclosure, the first, second, and extension sections of the optical connectors may be made of glass, ceramic, high-temperature plastic, stainless steel, and other heat-tolerant materials. For example, a high-temperature plastic such as PEEK/liquid crystalline polymer may be used for a present optical connector housing/body (i.e., the first and second sections, as well as the extension section) for tolerance to package solder reflow temperature of up to 260 C°.

FIG. 2 shows an exemplary representation of an optical package assembly 200 with an on-package optical connector or optical connector 201 and optical package 202 having a PIC 203, which may be attached to an assembly platform 204, according to another aspect of the present disclosure. In an aspect, an extension fiber array or first fiber array 205e may have a first end that may be attached to the optical connector 201 and a second end may be attached to an extension section 201c. In addition, an expanded beam fiber array or second fiber array 205 may have a first end that may be attached to the extension section 201c and a second end connected to the PIC 203.

As shown in FIG. 2, the optical connector 201 be disposed proximally to an edge of the assembly platform 204, which may extend further from the PIC 203, and may be facilitated through the use of the extension fiber array 205e and the extension section 201c. In addition, the optical connector 201 may be attached to an expanded beam jumper 206 for coupling the PIC 203 with other components. In an aspect, heights or first thicknesses for the optical connector 201 and extension section 201c should be less than a height or second thickness of the optical package 202.

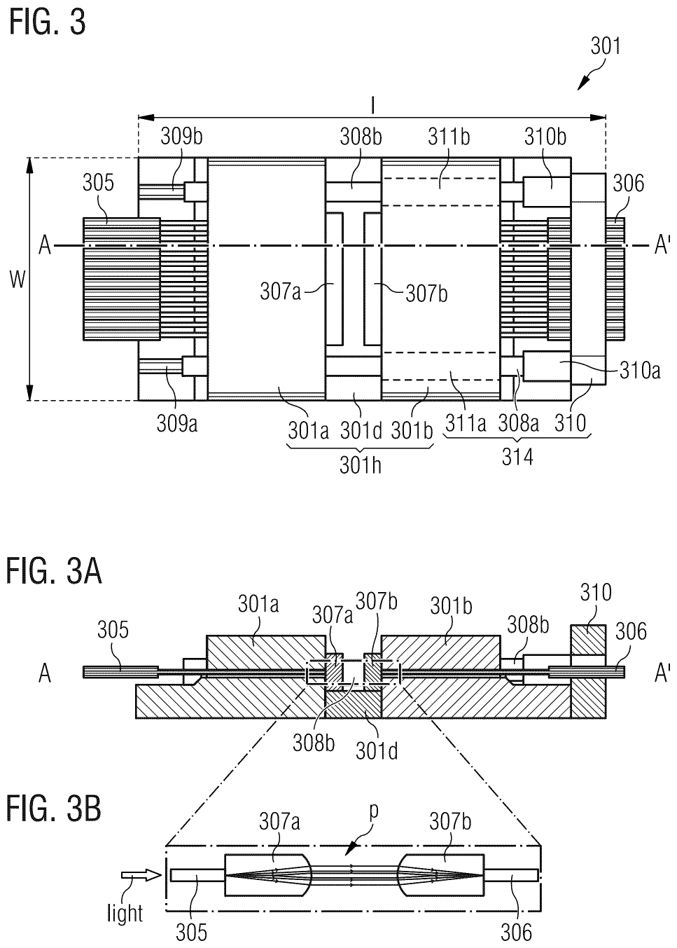

FIG. 3 shows an exemplary representation of an on-package optical connector or optical connector 301 and the features therein, and FIG. 3A shows an aspect of the optical connector 301 in a cross-sectional view along an A-A′ line in FIG. 3, with a representation of a functional aspect of the optical connector 301 shown in FIG. 3B, according to aspects of the present disclosure. In the aspect shown in FIG. 3, the optical connector 301 may have a housing or body 301h with a first section 301a and a second section 301b, which may be separated by a spacing member 301d. In this aspect, a fiber array 305 may be attached to the first section 301a and coupled to a first micro lens array (MLA) 307a, and an expanded beam jumper 306 may be attached to the second section 301b and coupled to a second MLA 307b.

The optical connector 301 may have an attachment assembly 314 that may have alignment members 308a and 308b, which may be pins attached in grooves 309a and 309b, respectively, that are formed in the first section 301a. The alignment members 308a and 308b may be inserted into alignment receptacles 311a and 311b, respectively, to detachably join the first and second sections 301a and 301b of the optical connector 301 in a self-aligned manner. The attachment assembly 314 may also include a locking mechanism 310 having collars 310a and 310b that fit over the alignment members 308a and 308b, respectively. The collars 310a and 310b may have slightly tapered inner cylindrical surfaces (not shown) to hold the alignment members 308a and 308b, respectively, by friction, or the inner cylindrical surfaces of the collars 310a and 310b may have circular ridges that fit into corresponding grooves (not shown) in the alignment members 308a and 308b, respectively. It should be understood that in alternative designs, the alignment receptacles may be in a first section on the package side and the alignment members may be in a second section on the jumper side (not shown).

In FIG. 3A, the first section 301a and the second section 301b are shown as being joined by the alignment member 308b and held in place by the locking mechanism 310. As shown, the spacing member 301d may be formed as an integral portion of the second section 301b, but, alternatively, may be formed as an integral portion of the first section 301a (not shown) or be provided on both the first and second sections (not shown). The first section 301a includes the fiber array 305 coupled to the first MLA 307a, and the second section 301b includes the jumper 306 coupled to the second MLA 307b.

In addition, as shown in FIG. 3B, an optical light beam signal may pass from the fiber array 305 to the first MLA 307a, which expands and collimates the light emitted from the fiber array 305 to form an expanded beam “p” having a diameter that may be many times that of the original light beam. The present micro lens arrays 307a and 307b must be precisely aligned to fiber arrays 305 and jumper 306 before attachment to first and second sections 301a and 301b, respectively, of the optical connector 301. The expanded beam technology expands and collimates the optical signal through the connector interface path. The expanded optical beam p may be refocused by the second MLA 307b into the core of the jumper 306 receiving fibers. The MLAs may have a size based on the number of channels needed by the optical package and may allow more tolerances to achieve passive alignment with minimum losses.

In another aspect, the present optical connectors must have height, width, and length dimensions that can be accommodated by the dimensions of the present optical package assembly; in particular, heights or first thicknesses for the first and second sections 301a and 301b being less than a height or second thickness of an optical package (not shown) incorporating the optical connector 301. For example, a present optical connector may have a height or first thickness of less than 2 mm, a width “w” of less than 6 mm, and a length “1” of approximately 12 mm, and an optical package may have a height or second thickness in the range of approximately 2 to 5 mm. It should be understood that as the number of fibers (or channels) increases, the width w may increase as well. For example, a 24-fiber configuration may be as wide as 12 mm. Additionally, a range of heights or thicknesses may be approximately 1 to 3 mm, and a range of length “1” may be approximately 12 to 22 mm for the present optical connectors.

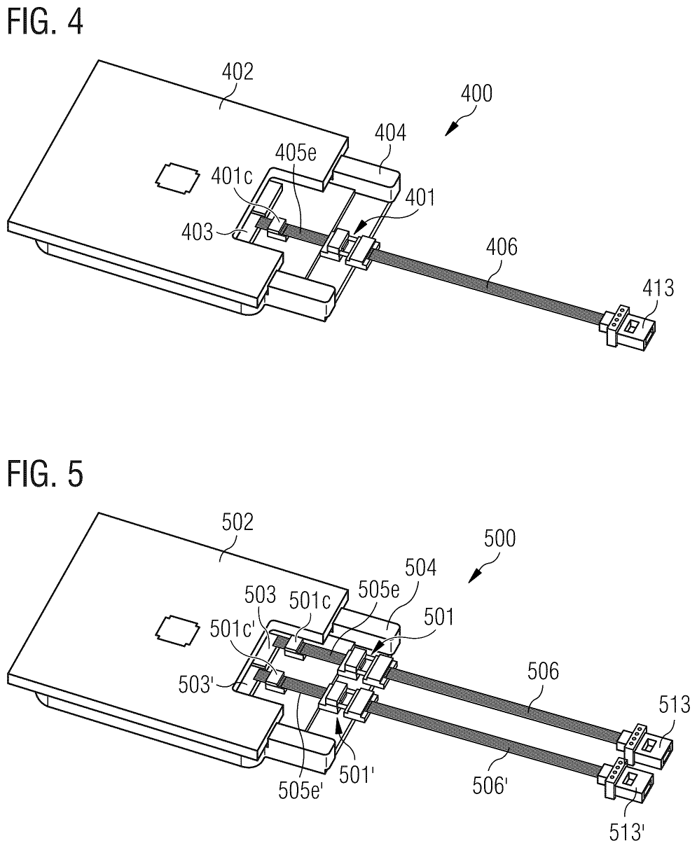

FIG. 4 shows an exemplary representation of an optical package assembly 400 with an on-package optical connector or optical connector 401 and an optical package 402 having a PIC 403, which may be attached to an assembly platform 404, according to another aspect of the present disclosure. In an aspect, an extension fiber array 405e may have a first end that may be attached to the optical connector 401 and a second end may be attached to an extension section 401c. In addition, an expanded beam fiber array or fiber array 405 may have a first end that may be attached to the extension section 401c and a second end connected to the PIC 403.

As shown in FIG. 4, the optical connector 401 be disposed proximally to an edge of the assembly platform 404, which may extend further from the PIC 403, and may be facilitated through the use of the extension fiber array 405e and the extension section 401c. In an aspect, heights or first thicknesses for the optical connector 401 and extension section 401c should be less than a height or second thickness of the optical package 402. In addition, the optical connector 401 may be attached to an expanded beam jumper 406 having a jumper connector 413 for coupling the PIC 403, and the optical package 402, with other components.

According to another aspect of the present disclosure, FIG. 5 shows an exemplary representation of an optical package assembly 500 with first and second on-package optical connectors or optical connectors 501 and 501′ and an optical package 502 having first and second PIC 503 and 503′, which may be attached to an assembly platform 504.

In this aspect, a first extension fiber array 505e may have a first end that may be attached to the first optical connector 501 and a second end may be attached to a first extension section 501c. In addition, a first expanded beam fiber array or fiber array 505 may have a first end that may be attached to the extension section 501c and a second end connected to the first PIC 503, and the first optical connector 501 may be attached to a first expanded beam jumper 506 having a first jumper connector 513 for coupling the first PIC 503 with other components.

In this aspect, a second extension fiber array 505e′ may have a first end that may be attached to the second optical connector 501′ and a second end may be attached to a second extension section 501c′. In addition, a second expanded beam fiber array or fiber array 505′ may have a first end that may be attached to the second extension section 501c′ and a second end connected to the PIC 503, and the second optical connector 501′ may be attached to a second expanded beam jumper 506 having a second jumper connector 513′ for coupling the second PIC 503′ with other components. It should be understood that an optical package assembly, according to the present disclosure, may have a plurality of PICs, e.g., three or more, as components of an optical package depending on the application, and accordingly, each PIC may have a present optical connector attached thereto.

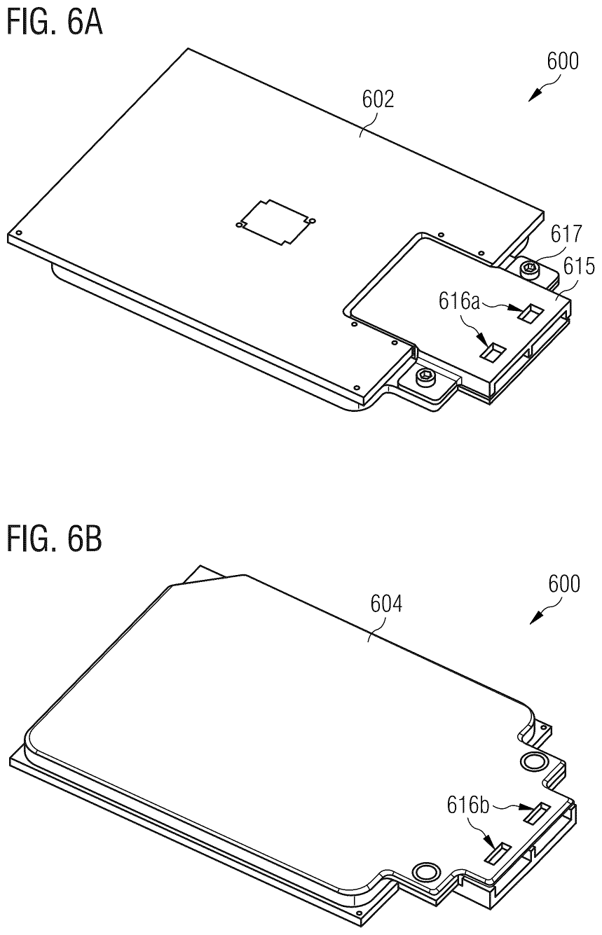

FIGS. 6A and 6B show exemplary representations of top and bottom views of an optical package assembly 600 according to aspects of the present disclosure. In the top view shown in FIG. 6A, the optical package assembly 600 may have an optical package 602 on an assembly platform 604, and a cover 615 with latching features 616a, which may be features of a locking mechanism (shown below). The latching features 616a may be a slot, or recess (not shown). The cover 615 may be secured to the assembly platform 604 by a pair of screws 617. The cover 615 may be detachable to enable the repair or replacement of an optical connector (not shown). In the bottom view shown in FIG. 6B, the assembly platform 604 may have latching features 616b, which may also be features of a locking mechanism. It should be understood that the latching features may be located on any side of a connector, i.e., top, bottom, and/or sides.

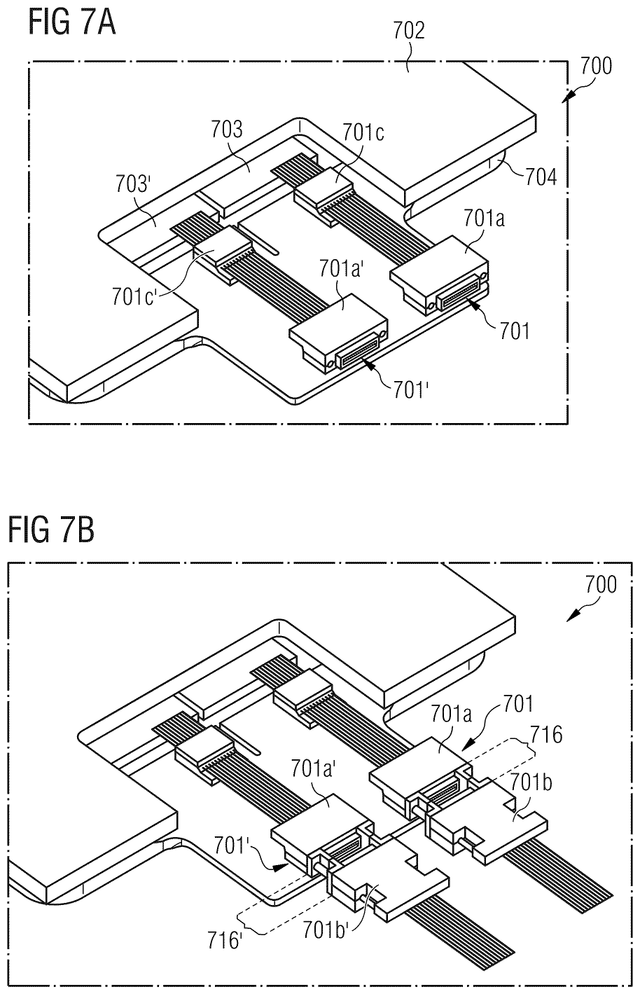

FIGS. 7A and 7B, show exemplary representations of an optical package assembly 700 according to yet another aspect of the present disclosure. In the aspect shown in FIG. 7A, a first optical connector (foc) 701 with a foc-first section 701a may be coupled to first photonic integrated circuits (PIC) 703, and a second optical connector (soc) 701′ with a soc-first section 701a′ may be coupled to a second PIC 703′, and both may be disposed on an assembly platform 704 along with an optical package 702. In an aspect, the heights or first thicknesses for the foc-first section 701a, the soc-first section 701a′, and extension sections 701c and 701c′ should be less than a height or second thickness of the optical package 702; namely, at least a portion of the housing of a present optical connector is configured with a first thickness that is less than a second thickness of the optical package.

In the aspect shown in FIG. 7B, the foc-first section 701a of the first optical connector 701 may be coupled to a foc-second section 701a of the first optical connector 701, and the soc-first section 701a′ of the second optical connector 701′ may be coupled to a with a soc-second section 701b′ of the second optical connector 701′. In this aspect, the foc-second section 701b of the first optical connector 701 and the soc-second section 701b′ of the second optical connector 701′ may not be disposed on the assembly platform 704 and may have different thicknesses from the foc-first section 701a of the first optical connector 701 and soc-second section 701b′ of the second optical connector 701′, e.g., the foc-second section 701b and the soc-second section 701b′ may have a greater thickness. In addition, the foc-first section 701a and the foc-second section 701b of the first optical connector 701 may be separated by spacing members 716, and the soc-first section 701a′ and the soc-second section 701b′ of the second optical connector 701′ may be separated by spacing members 716′.

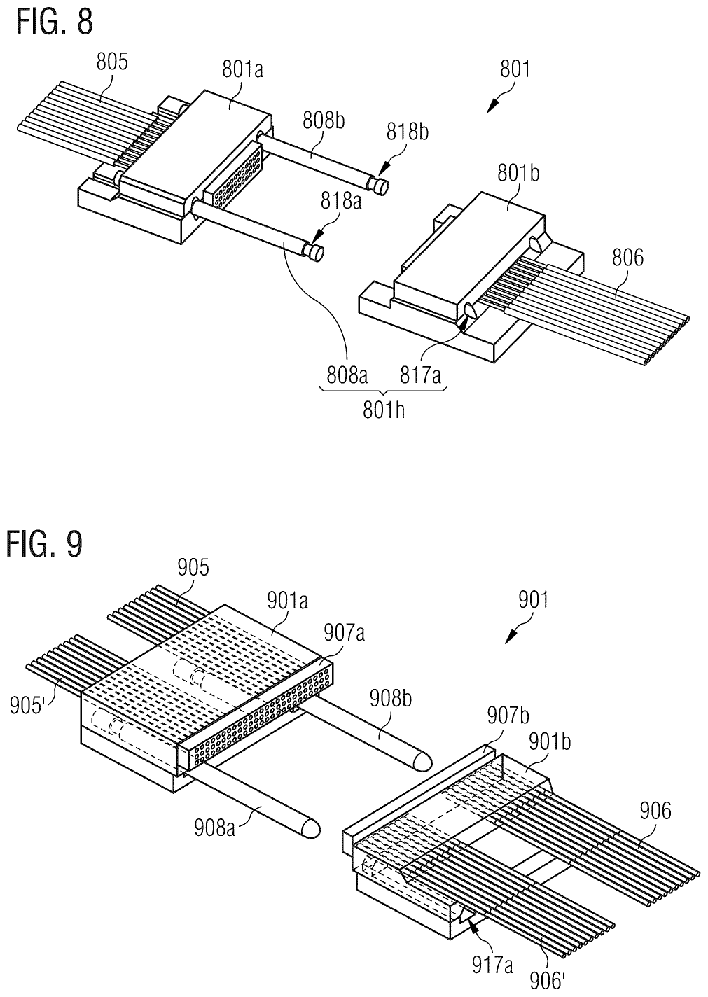

According to another aspect of the present disclosure, FIG. 8 shows an exemplary representation of features of an attachment assembly 801h of an on-package optical connector 801 according to an aspect of the present disclosure. In this aspect, the optical connector 801 may have a first section 801a with alignment members 808a and 808b, and a fiber array 805 may be attached to the first section 801a. The alignment member 808a may include a groove 818a and the alignment member 808b may include a groove 818b, which may be used to engage a locking mechanism (not shown). In addition, the optical connector 801 may have a second section 801b with alignment members receptacles 817a and 808b, and a jumper 806 may be attached to the second section 801b. When joining the first and second sections 801a and 801b, the alignment member 808a may be inserted in the alignment member receptacle 817a and the alignment member 808b may be inserted in the alignment member receptacle 817b. It should be understood that in alternative designs, the alignment receptacles may be in a first section on the package side and the alignment members may be in a second section on the jumper side (not shown).

FIG. 9 shows an exemplary representation of an on-package optical connector 901 according to another aspect of the present disclosure. In this aspect, the optical connector 901 may have a wider first section 901a with alignment members 908a and 908b, and first and second fiber arrays 905 and 905′ may be attached to the wider first section 901a. In an aspect, the number of fiber arrays and fiber channels may increase according to a specific application. In addition, the optical connector 901 may have a wider second section 901b with a first alignment member receptacle 917a and a second alignment member receptacle (not shown), and jumpers 906 and 906′ may be attached to the wider second section 901b. When joining the first and second sections 901a and 901b, the alignment member 908a may be inserted in the alignment member receptacle 917a and the alignment member 908b may be inserted in the second alignment member receptacle (not shown). It should be understood that in alternative designs, the alignment receptacles may be in a first section on the package side and the alignment members may be in a second section on the jumper side (not shown).

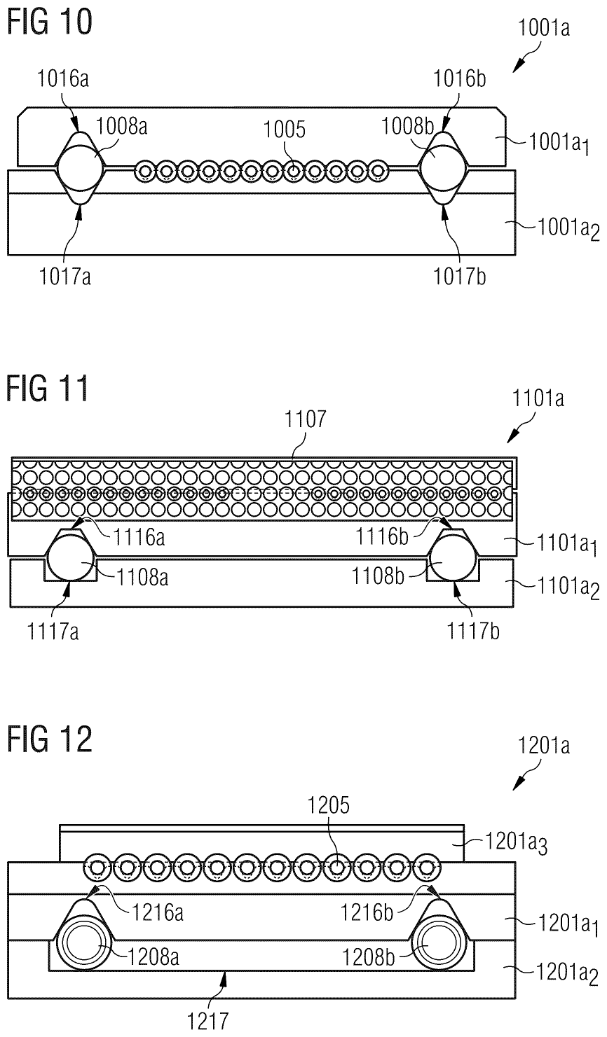

FIG. 10 shows an exemplary representation of alignment members of the present on-package optical connector according to an aspect of the present disclosure. In this aspect, a first section 1001a of an optical connector may have a top portion 1001a1 and a bottom portion 1001a2, and a fiber array 1005 may be attached between them. The top portion 1001a1 may have a first top groove 1016a and a second top groove 1016b, and the bottom portion 1001a2 may have a first bottom groove 1017a and a second bottom groove 1017b. In an aspect, the first top groove 1016a and the first bottom groove 1017a may have a first alignment member 1008a disposed between them, and the second top groove 1016b and the second bottom groove 1017b may have a second alignment member 1008b disposed between them. In an aspect, the first alignment member 1008a and the second alignment member 1008b may be a pin or cylindrically shaped as shown. In another aspect, the alignment members may be assembled into the grooves in the connector housings in a similar manner as the fiber array into fiber v-grooves.

It should be understood that present grooves for the alignment members may have a variety of shapes; for example, they may have a cylindrical shape, a square shape, a triangle shape, a hexagonal shape, a U shape, or combinations thereof. Similarly, it should be understood that present grooves for the alignment members may have a variety of shapes; for example, they may have a V-shape, a U-shape, a trapezoidal shape, or a semi-circular shape, or combinations thereof. The choice of shape may depend on manufacturing capability and being able to meet the tolerance requirements.

FIG. 11 shows an exemplary representation of alignment members of the present on-package optical connector according to another aspect of the present disclosure. In this aspect, a first section 1101a of an optical connector may have a top portion 1101a1 and a bottom portion 1101a2, and a micro lens array 1107 may be attached to the top portion 1101a1. The top portion 1101a1 may have a first top groove 1116a and a second top groove 1116b, and the bottom portion 1101a2 may have a first bottom groove 1117a and a second bottom groove 1117b. In this aspect, the first top groove 1116a and the second top groove 1116b may have an inverted U-shape, while the first bottom groove 1117a and a second bottom groove 1117b may have a rectangular shape, i.e., the top and bottom grooves may have different shapes. The first top groove 1116a and the first bottom groove 1117a may have a first alignment member 1108a disposed between them, and the second top groove 1116b and the second bottom groove 1117b may have a second alignment member 1108b disposed between them. In an aspect, the first alignment member 1108a and the second alignment member 1108b may be disposed below the micro lens array 1107. In an aspect, the first alignment member 1108a and the second alignment member 1108b may be a pin or rod-like structure as shown.

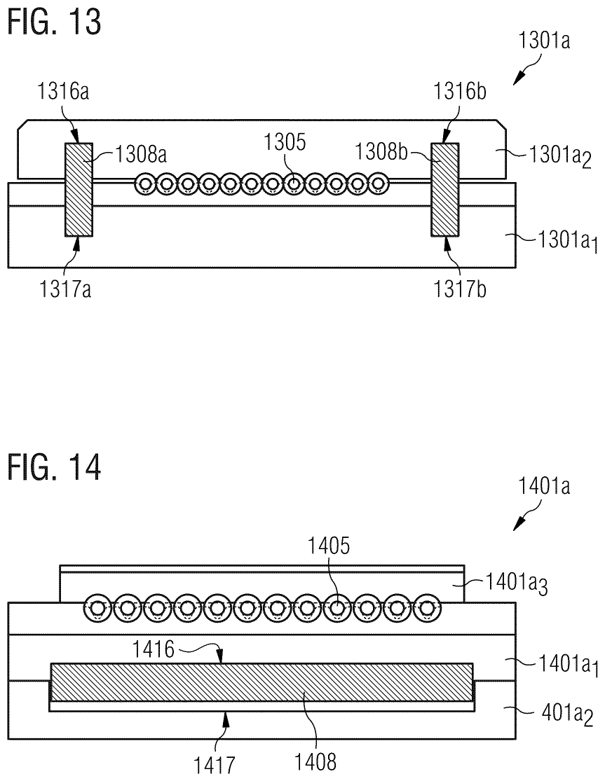

FIG. 12 shows an exemplary representation of alignment members of the present on-package optical connector according to yet another aspect of the present disclosure. In this aspect, a first section 1201a of an optical connector may have a top portion 1201a1 and a bottom portion 1201a2, and having a fiber array 1205 that may be disposed on the top portion 1201a1 and may be covered by an uppermost portion 1201a3. The top portion 1201a1 may have a first top groove 1216a and a second top groove 1216b, and the bottom portion 1201a2 may have a bottom slot-recess 1217. A first alignment member 1208a may be disposed between the first top groove and the bottom slot-recess 1217, and a second alignment member 1208b disposed between the second top groove 1216b and the bottom slot-recess 1217. In an aspect, the first alignment member 1208a and the second alignment member 1208b may be disposed below the fiber array 1205. In an aspect, the first alignment member 1208a and the second alignment member 1208b may be a pin or similarly shaped structure.

FIG. 13 shows an exemplary representation of alignment members of the present on-package optical connector according to an additional aspect of the present disclosure. In this aspect, a first section 1301a of an optical connector may have a top portion 1301a1 and a bottom portion 1301a2, and a fiber array 1305 may be attached between them. The top portion 1301a1 may have a first top slot 1316a and a second top slot 1316b, and the bottom portion 1301a2 may have a first bottom slot 1317a and a second bottom slot 1317b. The first top slot 1316a and the first bottom slot 1317a may have a first alignment member 1308a disposed between them, and the second top slot 1316b and the second bottom slot 1317b may have a second alignment member 1308b disposed between them. In an aspect, the first alignment member 1308a and the second alignment member 1308b may be a rectangular bar or similarly shaped.

FIG. 14 shows an exemplary representation of an alignment member of the present on-package optical connector according to a further additional aspect of the present disclosure. In this aspect, a first section 1401a of an optical connector may have a top portion 1401a1 and a bottom portion 1401a2, and have a fiber array 1405 disposed on the top portion 1401a1, which may be covered by an uppermost portion 1401a3. The top portion 1401a1 may have a top slot-recess 1416 and the bottom portion 1401a2 may have a bottom slot-recess 1417. An alignment member 1408 may be disposed between the top slot-recess 1416 and the bottom slot-recess 1417. In an aspect, the alignment member 1408 may be a rectangular plate that is disposed below the fiber array 1405.

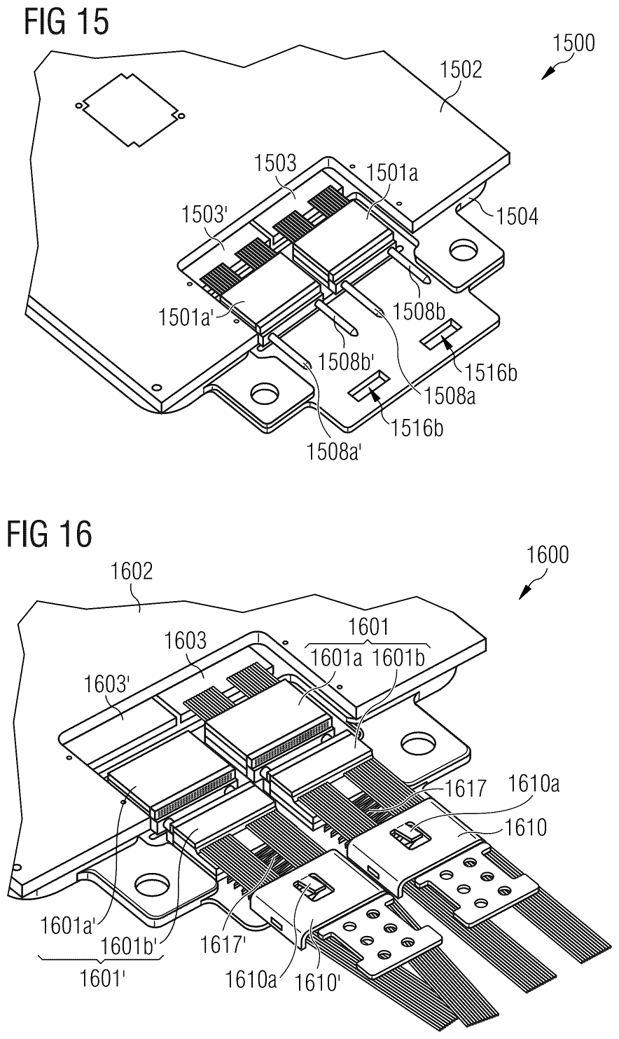

FIG. 15 shows an exemplary representation of on-package optical connectors according to an aspect of the present disclosure. In this aspect, an optical package assembly 1500 may include an optical package 1502, a foc-first section 1501a of a first optical connector (foc), which may be coupled to a first photonic integrated circuit (PIC) 1503, and a soc-first section 1501a′ of a second optical connector, which may be coupled to a second PIC 1503′, are disposed on the assembly platform 1504. The foc-first section 1501a may have a foc-first alignment member 1508a and the foc-second alignment member 1508b, and the soc-first section 1501a′ may have a soc-first alignment member 1508a′ and a soc-second alignment member 1508b′. It should be understood that in alternative designs, the alignment receptacles may be in a first section on the package side and the alignment members may be in a second section on the jumper side (not shown). In another aspect, the assembly platform 1504 may have latching features or slots 1516b, which may be features of a locking mechanism. In alternative designs, the latching features 1516b may be configured as recesses.

FIG. 16 shows an exemplary representation of on-package optical connectors according to an aspect of the present disclosure. In this aspect, an optical package assembly 1600 may include an optical package 1602, a first PIC 1603, a second PIC 1603′, a first optical connector (foc) 1601 having a foc-first section 1601a joined to a foc-second section 1601b, and a second optical connector (soc) 1601′ having a soc-first section 1601a′ joined to a soc-second section 1601b′, which are disposed on an assembly platform 1604. In this aspect, the first optical connector 1601 may have a first locking mechanism 1610 including a first body with a foc-first locking latch 1610a, a foc-second locking latch on a bottom side of the first body (not shown), and a first spring 1617, which induces and retains a contact force between the foc-first section 1601a and the foc-second section 1601b, and a second optical connector 1601′ may have a second locking mechanism 1610′ including a second body with a soc-first locking latch 1610a′, a soc-second locking latch on a bottom side of the second body (not shown) and a second spring 1617′, which induces and retains contact force between the soc-first section 1601a′ and the soc-second section 1601b′. The locking mechanisms 1610 and 1610′ may be positioned to engage the foc-second section 1601b and soc-second section 1601b′, respectively, and hold them in place, while the first and second springs 1618 and 1618′ assist in the removal of locking mechanisms 1610 and 1610′, respectively.

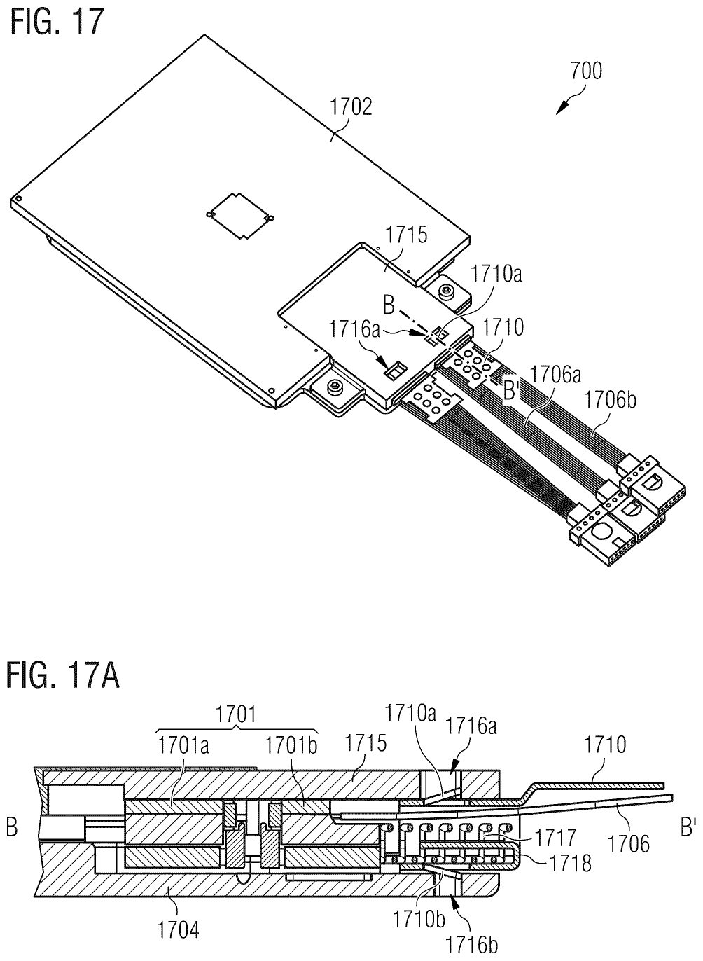

FIG. 17 shows an exemplary representation of an optical package assembly 1700 with on-package optical connectors, and FIG. 17A shows a cross-sectional view of a locking mechanism 1710 for an optical connector according to an aspect of the present disclosure. In FIG. 17, the optical assembly 1700 may include a pair of optical connectors (not shown), for which a first optical connector may be connected to jumpers 1706a and 1706b and held in position by a locking mechanism 1710 has a first locking latch 1710a. The locking latch 1710a may engage a latching feature 1716a, e.g., a slot, in a cover 1715 when the locking mechanism 1710 is pushed into position to keep a first and second sections of an optical connector (not shown) together.

FIG. 17A provides a cross-sectional view along the B-B′ line in FIG. 17. In this aspect, a first connector 1701 is shown with the locking mechanism 1710 engaging a second section 1701b and keeping it joined with a first section 1701a. In this aspect, the cover 1715 may have the first latching feature 1716a, e.g., a slot, and an assembly platform 1704 may have a second latching feature 1716b, e.g., a slot, and the first locking latch 1710a engages the first latching feature 1716a and a second locking latch 1710b engages the second latching 1716b. The locking mechanism 1710 may also have a spring holder 1718 that holds a spring 1717 in place when the first and second sections 1701a and 1701b are joined. In alternative designs, the latching features 1716a and 1716b may be configured as recesses rather than slots.

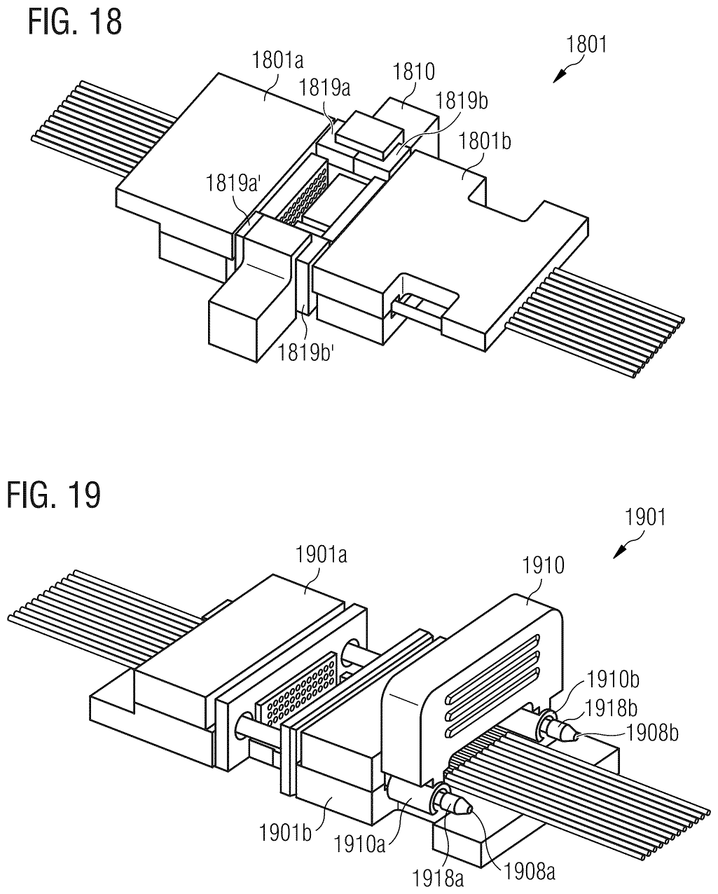

FIG. 18 shows an exemplary representation of a locking mechanism 1810 for an on-package optical connector 1801 according to an aspect of the present disclosure. The optical connector 1801 may include a first section 1801a having a first right bracket 1819a and a first left bracket 1819a′ and a second section 1801b having a second right bracket 1819b and a second left bracket 1819b′. The locking mechanism 1810 may be disposed between the first right bracket 1819a and the second right bracket 1819b on one side, and the first left bracket 1819a′ and the second left bracket 1819b′ on the other side. In an aspect, the locking mechanism 1810 may be a single magnet or a pair of magnets (not shown), which includes, as components of a locking assembly, the first right bracket 1819a, the first left bracket 1819a′, the second right bracket 1819b, and the second left bracket 1819b′ that are made of a ferromagnetic material.

FIG. 19 shows an exemplary representation of a locking mechanism 1910 for an on-package optical connector 1901 according to another aspect of the present disclosure. The optical connector 1901 may have a first section 1901a and a second section 1901b that are joined by first and second alignment members 1908a and 1908b. The locking mechanism 1910 may have first and second collars 1910a and 1910b that are disposed on the first and second alignment members 1908a and 1908b, respectively. In an aspect, the first alignment member 1908a may have a first ring band 1918a and the second alignment member 1908b may have a second ring band 1918a to prevent the movement of the locking mechanism 1910.

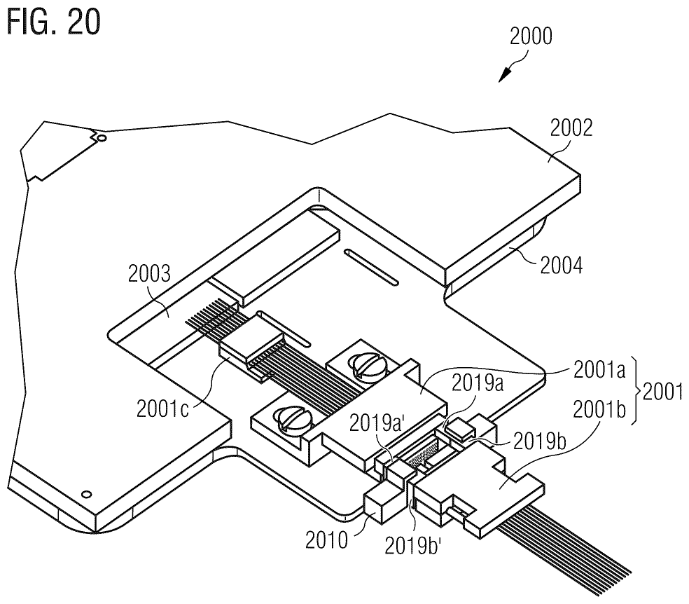

FIG. 20 shows an exemplary representation of an on-package optical connector 2001 for an optical assembly 2000 according to a further aspect of the present disclosure. In this aspect, the optical assembly may include the optical connector 2001 having a first section 2001a, a second section 2001b, an extension section 2001c, and a photonic integrated circuit (PIC) 2003 on an assembly platform 2004.

As shown in FIG. 20, the optical connector 2000 may include the first section 2001a having a first right bracket 2019a and a first left bracket 2019a′ and the second section 2001b having a second right bracket 2019b and a second left bracket 2019b′. The locking mechanism 2010 may be disposed between the first right bracket 2019a and the second right bracket 2019b on one side, and the first left bracket 2019a′ and the second left bracket 2019b′ on the other side. In aspect, the locking mechanism 2010 may be a magnet and include, as components of a locking assembly, the first right bracket 2019a, the first left bracket 2019a′, the second right bracket 2019b, and the second left bracket 2019b′, which may be features of made of a ferromagnetic material.

FIG. 21 shows a simplified flow diagram for an exemplary method 2100 according to an aspect of the present disclosure.

The operation 2101 may be directed to providing an assembly platform.

The operation 2102 may be directed to disposing a photonic integrated circuit on the assembly platform to form an optical package.

The operation 2103 may be directed to providing an optical connector having a thin housing with a first section and a second section, and an attachment assembly.

The operation 2104 may be directed to disposing the first section of the optical connector at an edge of the assembly platform.

The operation 2105 may be directed to performing one or more surface mounting processes to attach the optical package with the photonic integrated circuit and the optical connectors to the assembly platform.

It will be understood that any property described herein for a particular expanded beam connector and method for its use and fabrication with a particular photonic integrated circuit package may also hold for any photonic integrated circuit package using the present expanded beam connector described herein. It will also be understood that any property described herein for a specific method may hold for any of the methods described herein. Furthermore, it will be understood that for any expanded beam connector and the methods described herein, not necessarily all the components or operations described will be shown in the accompanying drawings or method, but only some (not all) components or operations may be disclosed.

To more readily understand and put into practical effect the photonic integrated circuits packages having present expanded beam connectors, they will now be described by way of examples. For the sake of brevity, duplicate descriptions of features and properties may be omitted.

### EXAMPLES

Example 1 provides an optical connector including a housing having a first section, a second section, and an attachment assembly, for which the attachment assembly joins the first section to the second section and enables the second section to be detached from the first section, and for which the first section of the housing is disposed proximally to an edge of a photonic integrated circuit that is a component of an optical package and is coupled to the photonic integrated circuit and the second section of the housing is coupled to a fiber optic jumper, and for which at least a portion of the housing is configured with a first thickness that is less than a second thickness of the optical package.

Example 2 may include the optical connector of example 1 and/or any other example disclosed herein, further including an extension section, a first fiber array unit having a first end and second end, and a second fiber array unit having a first end and second end, and for which the first end of the first fiber array unit is attached to the first section of the housing and the second end of the first fiber array unit is attached to the extension section, and the first end of the second fiber array unit is attached to the extension section and the second end of the second fiber array unit is attached to the photonic integrated circuit, for which the extension section is disposed between the edge of the photonic integrated circuit and the first section of the housing.

Example 3 may include the optical connector of example 1 and/or any other example disclosed herein, for which the first section of the housing includes a first micro lens array and the second section of the housing includes a second micro lens array, for which the first micro lens array is aligned with the second micro lens array when the first and second sections are joined together.

Example 4 may include the optical connector of example 3 and/or any other example disclosed herein, for which the first section or second section is provided with a spacing member to provide a space between the first and second micro lens arrays when the first and second sections are joined together.

Example 5 may include the optical connector of example 1 and/or any other example disclosed herein, for which the attachment assembly includes an alignment member, an alignment member receptacle, and a locking mechanism, and for which the alignment member is configured to be inserted into the alignment member receptacle and the alignment member receptacle is configured with a shape that is complementary with the alignment member, and for which the locking mechanism is configured to hold the alignment member in the alignment member receptacle after the alignment member is inserted.

Example 6 may include the optical connector of example 5 and/or any other example disclosed herein, for which the alignment member includes a rod-like structure and the alignment member receptacle includes a cavity to receive the rod-like structure.

Example 7 may include the optical connector of example 5 and/or any other example disclosed herein, for which the alignment member includes a rectangular structure and the alignment member receptacle includes a rectangular cavity to receive the rectangular structure.

Example 8 may include the optical connector of example 6 and/or any other example disclosed herein, for which the locking mechanism includes a body with a collar that fits around the rod-like structure.

Example 9 may include the optical connector of example 5 and/or any other example disclosed herein, for which the locking mechanism includes a body with a lever structure and a spring that engages the second section of the housing.

Example 10 may include the optical connector of example 1 and/or any other example disclosed herein, for which the locking mechanism includes one or more magnets disposed between the first section and the second section of the housing.

Example 11 may include the optical connector of example 1 and/or any other example disclosed herein, for which the housing includes a glass, ceramics, high-temperature plastics, stainless steel, and other heat-tolerant materials.

Example 12 provides a method for providing an assembly platform, disposing an optical package with a photonic integrated circuit on the assembly platform to form a package assembly, providing an optical connector including a housing with a first section and a second section, and an attachment assembly, disposing the first section of the optical connector at an edge of the assembly platform, and performing one or more surface mounting processes to attach the photonic integrated circuit and other components to the assembly platform, for which at least a portion of the housing is configured with a first thickness that is less than a second thickness of the optical package and is formed using heat tolerant materials suitable for the surface mounting processes.

Example 13 may include the method of example 12 and/or any other example disclosed herein, which further includes disposing a cover over the first section of the optical connector and attaching the cover to the assembly platform.

Example 13 may include the method of example 12 and/or any other example disclosed herein, which further includes joining the second section of the optical connector with the first section of the optical connector, for which the first and second sections are aligned and held together by the attachment assembly.

Example 15 provides a package assembly including an assembly platform, a photonic integrated circuit disposed on the assembly platform, and an optical connector including a housing with a first section and a second section, and an attachment assembly, for which the first section of the housing is disposed proximally to an edge of the assembly platform and is coupled to the photonic integrated circuit in the optical package and the second section of the housing is coupled to a fiber optic jumper, and for which the attachment assembly joins the second section to the first section and enables the second section to be detached from the first section, and for which at least a portion of the housing is configured with a first thickness that is less than a second thickness of the optical package.

Example 16 may include the package assembly of example 15 and/or any other example disclosed herein, for which the photonic integrated circuit further includes two or more photonic integrated circuits, and for which the optical connector further includes two or more optical connectors, and for which the two or more optical connectors are correspondingly coupled to the two or more photonic integrated circuits.

Example 17 may include the package assembly of example 15 and/or any other example disclosed herein, for which the first section of the housing includes a first micro lens array and the second section of the housing includes a second micro lens array, for which the first micro lens array is aligned with the second micro lens array when the first and second sections are joined together.

Example 18 may include the package assembly of example 15 and/or any other example disclosed herein, for which the attachment assembly of the optical connector includes an alignment member, an alignment member receptacle, and a locking mechanism, and for which the alignment member is configured to be inserted into the alignment member receptacle and the alignment member receptacle is configured with a shape that is complementary with the alignment member, and for which the locking mechanism is configured to hold the alignment member in the alignment member receptacle after being inserted.

Example 19 may include the package assembly of example 15 and/or any other example disclosed herein, further includes a detachable cover disposed over at least the first section of the housing.

Example 20 may include the package assembly of example 15 and/or any other example disclosed herein, for which the assembly platform includes an integrated heat spreader.

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise” and “comprises”.

The term “coupled” (or “connected”) herein may be understood as electrically coupled or as mechanically coupled, e.g., attached or fixed or attached, or just in contact without any fixation, and it will be understood that both direct coupling or indirect coupling (in other words: coupling without direct contact) may be provided.

The terms “and” and “or” herein may be understood to mean “and/or” as including either or both of two stated possibilities.

While the present disclosure has been particularly shown and described with reference to specific aspects, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

What is claimed is:

1. An optical connector comprising:
a housing comprising a first section, a second section, and an attachment assembly, wherein the attachment assembly joins the first section to the second section and enables the second section to be detached from the first section;
wherein the first section of the housing is disposed proximally to an edge of a photonic integrated circuit that is a component of an optical package and is coupled to the photonic integrated circuit, and the second section of the housing is coupled to a fiber optic jumper; and
wherein at least a portion of the housing is configured with a first thickness that is less than a second thickness of the optical package.

2. The optical connector of claim 1, further comprising an extension section, a first fiber array unit having a first end and second end, and a second fiber array unit having a first end and second end; and
wherein the first end of the first fiber array unit is attached to the first section of the housing and the second end of the first fiber array unit is attached to the extension section, and the first end of the second fiber array unit is attached to the extension section and the second end of the second fiber array unit is attached to the photonic integrated circuit, wherein the extension section is disposed between the edge of the photonic integrated circuit and the first section of the housing.

3. The optical connector of claim 1, wherein the first section of the housing comprises a first micro lens array and the second section of the housing comprises a second micro lens array, wherein the first micro lens array is aligned with the second micro lens array when the first and second sections are joined together.

4. The optical connector of claim 3, wherein the first section or second section is provided with a spacing member to provide a space between the first and second micro lens arrays when the first and second sections are joined together.

5. The optical connector of claim 1, wherein the attachment assembly comprises an alignment member, an alignment member receptacle, and a locking mechanism,
wherein the alignment member is configured to be inserted into the alignment member receptacle and the alignment member receptacle is configured with a shape that is complementary to the alignment member, and
wherein the locking mechanism is configured to hold the alignment member in the alignment member receptacle after the alignment member is inserted.

6. The optical connector of claim 5, wherein the alignment member comprises a rod-like structure and the alignment member receptacle comprises a cavity to receive the rod-like structure.

7. The optical connector of claim 5, wherein the alignment member comprises a rectangular structure and the alignment member receptacle comprises a rectangular cavity to receive the rectangular structure.

8. The optical connector of claim 6, wherein the locking mechanism comprises a body with a collar that fits around the rod-like structure.

9. The optical connector of claim 5, wherein the locking mechanism comprises a body with a lever structure and a spring that engages the second section of the housing.

10. The optical connector of claim 5, wherein the locking mechanism comprises one or more magnets disposed between the first section and the second section of the housing.

11. The optical connector of claim 1, wherein the housing comprises glass, ceramic, high-temperature plastic, stainless steel, and other heat-tolerant materials.

12. A method comprising:
providing an assembly platform;
disposing an optical package with a photonic integrated circuit on the assembly platform to form a package assembly;
providing an optical connector comprising a housing with a first section and a second section, and an attachment assembly;
disposing the first section of the optical connector at an edge of the assembly platform; and
performing one or more surface mounting processes to attach the photonic integrated circuit and other components to the assembly platform,
wherein at least a portion of the housing is configured with a first thickness that is less than a second thickness of the optical package and is formed using heat-tolerant materials suitable for the surface mounting processes.

13. The method of claim 12, further comprises disposing a cover over the first section of the optical connector and attaching the cover to the assembly platform.

14. The method of claim 12, further comprises joining the second section of the optical connector with the first section of the optical connector, wherein the first and second sections are aligned and held together by the attachment assembly.

15. A package assembly comprising:
an assembly platform;
an optical package comprising a photonic integrated circuit disposed on the assembly platform; and
an optical connector comprising a housing with a first section and a second section, and an attachment assembly,
wherein the first section of the housing is disposed proximally to an edge of the assembly platform and is coupled to the photonic integrated circuit in the optical package and the second section of the housing is coupled to a fiber optic jumper,
wherein the attachment assembly joins the second section to the first section and enables the second section to be detached from the first section,
and
wherein at least a portion of the housing is configured with a first thickness that is less than a second thickness of the optical package.

16. The package assembly of claim 15, wherein the photonic integrated circuit further comprises two or more photonic integrated circuits, and wherein the optical connector further comprises two or more optical connectors, and
wherein the two or more optical connectors are correspondingly coupled to the two or more photonic integrated circuits.

17. The package assembly of claim 15, wherein the first section of the housing comprises a first micro lens array and the second section of the housing comprises a second micro lens array, wherein the first micro lens array is aligned with the second micro lens array when the first and second sections are joined together.

18. The package assembly of claim 15, wherein the attachment assembly of the optical connector comprises an alignment member, an alignment member receptacle, and a locking mechanism, wherein the alignment member is configured to be inserted into the alignment member receptacle and the alignment member receptacle is configured with a shape that is complementary with the alignment member, and
wherein the locking mechanism is configured to hold the alignment member in the alignment member receptacle after being inserted.

19. The package assembly of claim 15, further comprises a detachable cover disposed over at least the first section of the housing.

20. The package assembly of claim 15, wherein the assembly platform comprises an integrated heat spreader.
